(19) United States
(12) Patent Application Publication
(10) Pub. No.: US 2017/0026524 A1
(43) Pub. Date: Jan. 26, 2017

(54) CHARGING METHOD AND APPARATUS

(71) Applicant: HUAWEI TECHNOLOGIES CO., LTD., Shenzhen (CN)

(72) Inventor: Huan LI, Shanghai (CN)

(73) Assignee: HUAWEI TECHNOLOGIES CO., LTD., Shenzhen (CN)

(21) Appl. No.: 15/284,410

(22) Filed: Oct. 3, 2016

Related U.S. Application Data
(63) Continuation of application No. PCT/CN2014/074860, filed on Apr. 4, 2014.

(51) Int. Cl. H04M 15/00; H04W 4/24

(52) U.S. Cl. CPC H04M 15/8038; H04W 4/24; H04M 15/43; H04M 15/66

(57) ABSTRACT

The present invention belongs to the field of mobile communications, and discloses a charging method and apparatus. The method includes: obtaining a mode of price calculation for the terminal used on a home network of a terminal; determining, according to the obtained mode of price calculation for the terminal, a network collecting element corresponding to the mode of price calculation for the terminal; and sending a price calculation indication message to the network collecting element to enable the network collecting element to collect price calculation information of the terminal and to report the price calculation information to a price calculation system, and the price calculation system charges the terminal according to the price calculation information. The apparatus includes: an obtaining module, a determining module, and a sending module. According to the present invention, a roaming terminal can be successfully charged.

### CROSS-REFERENCE TO RELATED APPLICATIONS

This application is a continuation of International Application No. PCT/CN2014/074860, filed on Apr. 4, 2014, which is hereby incorporated by reference in its entirety.

### TECHNICAL FIELD

The present invention relates to the field of mobile communications, and in particular, to a charging method and apparatus.

### BACKGROUND

In a roaming scenario, a user terminal roams from a home location to a visited location, and accesses a network of the visited location. In this case, if the user terminal performs communication, a server of the visited location needs to obtain price calculation information of the user terminal, and charges the user terminal according to the obtained price calculation information.

Currently, on networks of different locations, price calculation information of a user terminal may be obtained by using different modes of price calculation for the user terminal, and the user terminal is charged according to the obtained price calculation information. Network collecting elements of different types are used in different modes of price calculation for the user terminal. When a user terminal roams to a visited location and accesses a network of the visited location, a server of the visited location sends a price calculation rule to a network collecting element corresponding to a mode of price calculation for the terminal used in the visited location. The network collecting element detects a communication operation of the user terminal in real time to obtain communication data of the user terminal. The network collecting element obtains price calculation information of the user terminal according to the communication data of the user terminal and the received price calculation rule, and sends the obtained price calculation information to a price calculation system. The price calculation system charges the user terminal according to the price calculation information.

In a process of implementing the present invention, it is found that the prior art at least has the following problems:

When a mode of price calculation for the terminal used on a home network of a user terminal is different from a mode of price calculation for the terminal used on a network of a visited location, if a price calculation system on the network of the visited location charges the user terminal by using the mode of price calculation for the terminal used on the network of the visited location, charging fails. However, a price calculation system on the home network provides no interface for invoking by a network collecting element corresponding to the mode of price calculation for the terminal used on the network of the visited location. Consequently, when the network collecting element sends price calculation information to the price calculation system on the home network, the price calculation system cannot successfully receive the price calculation information sent by the network collecting element, causing a charging failure.

### SUMMARY

To successfully charge a roaming terminal online, the present invention provides a charging method and apparatus. The technical solutions are as follows:

According to a first aspect, a charging method is provided, where the method includes:
obtaining a mode of price calculation for the terminal used on a home network of a terminal;
determining, according to the obtained mode of price calculation for the terminal, a network collecting element corresponding to the mode of price calculation for the terminal; and
sending a price calculation indication message to the network collecting element, so that the network collecting element collects price calculation information of the terminal and reports the price calculation information to a price calculation system, and the price calculation system charges the terminal according to the price calculation information.

With reference to the first aspect, in a first possible implementation manner of the first aspect, the obtaining a mode of price calculation for the terminal used on a home network of a terminal includes:
receiving the mode of price calculation for the terminal that is used on the home network of the terminal and that is sent by a policy and charging enforcement function (PCEF); or
receiving a terminal identifier sent by a PCEF, obtaining a network identifier of the home network of the terminal from the terminal identifier, and obtaining, according to the obtained network identifier and a stored correspondence between a network identifier and a mode of price calculation for the terminal, the mode of price calculation for the terminal used on the home network of the terminal.

With reference to the first aspect, in a second possible implementation manner of the first aspect, before the obtaining a mode of price calculation for the terminal used on a home network of a terminal, the method further includes:
obtaining a network identifier of each network and a mode of price calculation for the terminal used on each network, and storing the obtained mode of price calculation used on each network and the obtained network identifier of each network according to a correspondence between the obtained network identifier and a mode of price calculation used on the network.

With reference to the first aspect, in a third possible implementation manner of the first aspect, the determining, according to the obtained mode of price calculation for the terminal, the network collecting element corresponding to the mode of price calculation for the terminal includes:
obtaining a type of a corresponding network collecting element according to the obtained mode of price calculation for the terminal and a stored correspondence between a mode of price calculation for the terminal and a type of a network collecting element, and determining the network collecting element corresponding to the obtained type as the network collecting element corresponding to the mode of price calculation for the terminal.

According to a second aspect, a charging method is provided, where the method includes:
obtaining a mode of price calculation for the terminal used on a home network of a terminal; and
notifying the mode of price calculation for the terminal to a policy and charging rules function PCRF to enable the PCRF to determine, according to the mode of price calculation for the terminal, a network collecting element corresponding to the mode of price calculation for the terminal, the network collecting element collecting price calculation information of the terminal and reporting the price calculation information to a price calculation system, and the price calculation system calculating the price for the terminal according to the price calculation information.

With reference to the second aspect, in a first possible implementation manner of the second aspect, the obtaining the mode of price calculation for the terminal used on the home network of a terminal includes:
obtaining a network identifier of the home network of the terminal from a terminal identifier of the terminal, and obtaining the corresponding mode of price calculation for the terminal according to the network identifier of the home network of the terminal and a stored correspondence between the obtained network identifier and a mode of price calculation used on the network.

With reference to the second aspect, in a second possible implementation manner of the second aspect, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between the obtained network identifier and a mode of price calculation used on the network.

With reference to the second aspect, in a third possible implementation manner of the second aspect, the notifying the mode of price calculation for the terminal to a PCRF includes:
sending the mode of price calculation for the terminal to the PCRF.

With reference to the second aspect, in a fourth possible implementation manner of the second aspect, the notifying the mode of price calculation for the terminal to a PCRF includes:
performing determining on the mode of price calculation for the terminal; and
if the mode of price calculation for the terminal is another mode of price calculation for the terminal except an AAA-based mode of price calculation for the terminal, sending a terminal identifier of the terminal to the PCRF, so that the PCRF obtains, according to the terminal identifier of the terminal, the mode of price calculation for the terminal used on the home network of the terminal.

With reference to the fourth possible implementation manner of the second aspect, in a fifth possible implementation manner of the second aspect, the method further includes:
if the mode of price calculation for the terminal is the AAA-based mode of price calculation for the terminal, sending a price calculation rule corresponding to the mode of price calculation for the terminal to an Internet Protocol Edge IP Edge, so that the IP Edge determines, according to the price calculation rule, that the home network of the terminal uses the AAA-based mode of price calculation for the terminal.

According to a third aspect, a charging method is provided, where the method includes:
obtaining a mode of price calculation for the terminal used on a home network of a terminal; and
sending an Internet Protocol-connectivity access network IP-CAN session request message to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

With reference to the third aspect, in a first possible implementation manner of the third aspect, the obtaining a mode of price calculation for the terminal used on a home network of a terminal includes:
receiving the mode of price calculation for the terminal that is used on the home network of the terminal and that is sent by an AAA; or
receiving a price calculation rule that is sent by an AAA when the AAA determines that the home network of the terminal uses an AAA-based mode of price calculation for the terminal, and determining, according to the price calculation rule, that the home network of the terminal uses the AAA-based mode of price calculation for the terminal; or
obtaining a terminal identifier of the terminal, obtaining a network identifier of the home network of the terminal according to the terminal identifier of the terminal, and obtaining, according to the network identifier of the home network of the terminal and a stored correspondence between a network identifier and a mode of price calculation for the terminal, the mode of price calculation for the terminal used on the home network of the terminal.

With reference to the third aspect, in a second possible implementation manner of the third aspect, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

With reference to the third aspect, in a third possible implementation manner of the third aspect, the sending an Internet Protocol-connectivity access network IP-CAN session request message to a PCRF includes:
if the mode of price calculation for the terminal is an AAA-based mode of price calculation for the terminal, sending the IP-CAN session request message to the PCRF, where the IP-CAN session request message carries the AAA-based mode of price calculation for the terminal.

With reference to the third possible implementation manner of the third aspect, in a fourth possible implementation manner of the third aspect, the method further includes:
if the mode of price calculation for the terminal is another mode of price calculation for the terminal except the AAA-based mode of price calculation for the terminal, sending the IP-CAN session request message to the PCRF, where the IP-CAN session request message carries the terminal identifier of the terminal.

According to a fourth aspect, a charging apparatus is provided, where the apparatus includes:
an obtaining module, configured to obtain a mode of price calculation for the terminal used on a home network of a terminal;
a determining module, configured to determine, according to the obtained mode of price calculation for the terminal, a network collecting element corresponding to the mode of price calculation for the terminal; and
a sending module, configured to send a price calculation indication message to the network collecting element, so that the network collecting element collects price calculation information of the terminal and reports the price calculation information to a price calculation system, and the price calculation system charges the terminal according to the price calculation information.

With reference to the fourth aspect, in a first possible implementation manner of the fourth aspect, the obtaining module includes:
a first receiving unit, configured to receive the mode of price calculation for the terminal that is used on the home network of the terminal and that is sent by a policy and charging enforcement function PCEF; or
a second receiving unit, configured to receive a terminal identifier sent by a PCEF, obtain a network identifier of the home network of the terminal from the terminal identifier, and obtain, according to the obtained network identifier and a stored correspondence between a network identifier and a mode of price calculation for the terminal, the mode of price calculation for the terminal used on the home network of the terminal.

With reference to the fourth aspect, in a second possible implementation manner of the fourth aspect, the apparatus further includes:
an obtaining and storage module, configured to obtain a network identifier of each network and a mode of price calculation for the terminal used on each network, and store the obtained mode of price calculation for the terminal used on each network and the obtained network identifier of each network according to a correspondence between a network identifier and a mode of price calculation for the terminal.

With reference to the fourth aspect, in a third possible implementation manner of the fourth aspect, the determining module is configured to obtain a type of a corresponding network collecting element according to the obtained mode of price calculation for the terminal and a stored correspondence between a mode of price calculation for the terminal and a type of a network collecting element, and determine the network collecting element corresponding to the obtained type as the network collecting element corresponding to the mode of price calculation for the terminal.

According to a fifth aspect, a charging apparatus is provided, where the apparatus includes:
an obtaining module, configured to obtain a mode of price calculation for the terminal used on a home network of a terminal; and
a notification module, configured to notify the mode of price calculation for the terminal to a policy and charging rules function PCRF, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

With reference to the fifth aspect, in a first possible implementation manner of the fifth aspect, the obtaining module is configured to obtain a network identifier of the home network of the terminal from a terminal identifier of the terminal, and obtain the corresponding mode of price calculation for the terminal according to the network identifier of the home network of the terminal and a stored correspondence between a network identifier and a mode of price calculation for the terminal.

With reference to the fifth aspect, in a second possible implementation manner of the fifth aspect, the apparatus further includes:
an obtaining and storage module, configured to obtain a network identifier of each network and a mode of price calculation for the terminal used on each network, and store the obtained mode of price calculation for the terminal used on each network and the obtained network identifier of each network according to a correspondence between a network identifier and a mode of price calculation for the terminal.

With reference to the fifth aspect, in a third possible implementation manner of the fifth aspect, the notification module is configured to send the mode of price calculation for the terminal to the PCRF.

With reference to the fifth aspect, in a fourth possible implementation manner of the fifth aspect, the notification module includes:
a determining unit, configured to perform determining on the mode of price calculation for the terminal; and
a sending module, configured to: if the mode of price calculation for the terminal is another mode of price calculation for the terminal except an AAA-based mode of price calculation for the terminal, send a terminal identifier of the terminal to the PCRF, so that the PCRF obtains, according to the terminal identifier of the terminal, the mode of price calculation for the terminal used on the home network of the terminal.

With reference to the fourth possible implementation manner of the fifth aspect, in a fifth possible implementation manner of the fifth aspect, the notification module is further configured to: if the mode of price calculation for the terminal is the AAA-based mode of price calculation for the terminal, send a price calculation rule corresponding to the mode of price calculation for the terminal to an Internet Protocol Edge IP Edge, so that the IP Edge determines, according to the price calculation rule, that the home network of the terminal uses the AAA-based mode of price calculation for the terminal.

According to a sixth aspect, a charging apparatus is provided, where the apparatus includes:
an obtaining module, configured to obtain a mode of price calculation for the terminal used on a home network of a terminal; and
a sending module, configured to send an Internet Protocol-connectivity access network IP-CAN session request message to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

With reference to the sixth aspect, in a first possible implementation manner of the sixth aspect, the obtaining module includes:
a first receiving unit, configured to receive the mode of price calculation for the terminal that is used on the home network of the terminal and that is sent by an AAA; or
a second receiving unit, configured to receive a price calculation rule that is sent by an AAA when the AAA determines that the home network of the terminal uses an AAA-based mode of price calculation for the terminal, and determine, according to the price calculation rule, that the home network of the terminal uses the AAA-based mode of price calculation for the terminal; or
an obtaining unit, configured to obtain a terminal identifier of the terminal, obtain a network identifier of the home network of the terminal according to the terminal identifier of the terminal, and obtain, according to the network identifier of the home network of the terminal and a stored correspondence between a network identifier and a mode of price calculation for the terminal, the mode of price calculation for the terminal used on the home network of the terminal.

With reference to the sixth aspect, in a second possible implementation manner of the sixth aspect, the apparatus further includes:
an obtaining and storage module, configured to obtain a network identifier of each network and a mode of price calculation for the terminal used on each network, and store the obtained mode of price calculation for the terminal used on each network and the obtained network identifier of each network according to a correspondence between a network identifier and a mode of price calculation for the terminal.

With reference to the sixth aspect, in a third possible implementation manner of the sixth aspect, the sending module is configured to: if the mode of price calculation for the terminal is an AAA-based mode of price calculation for the terminal, send the IP-CAN session request message to the PCRF, where the IP-CAN session request message carries the AAA-based mode of price calculation for the terminal.

With reference to the third possible implementation manner of the sixth aspect, in a fourth possible implementation manner of the sixth aspect, the sending module is further configured to: if the mode of price calculation for the terminal is another mode of price calculation for the terminal except the AAA-based mode of price calculation for the terminal, send the IP-CAN session request message to the PCRF, where the IP-CAN session request message carries the terminal identifier of the terminal.

According to a seventh aspect, a charging apparatus is provided, where the apparatus includes:
a first memory and a first processor, configured to execute the method according to any one of claims 1 to 4.

According to an eighth aspect, a charging apparatus is provided, where the apparatus includes:
a second memory and a second processor, configured to execute the method according to any one of claims 5 to 10.

According to a ninth aspect, a charging apparatus is provided, where the apparatus includes:
a third memory and a third processor, configured to execute the method according to any one of claims 11 to 15.

In embodiments of the present invention, a mode of price calculation for the terminal used on a home network of a terminal is obtained; a network collecting element corresponding to the mode of price calculation for the terminal is determined according to the obtained mode of price calculation for the terminal; and a price calculation indication message is sent to the network collecting element, so that the network collecting element collects price calculation information of the terminal, and a price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### BRIEF DESCRIPTION OF DRAWINGS

FIG. 1 is a flowchart of a charging method according to Embodiment 1 of the present invention;

FIG. 2A, FIG. 2B, and FIG. 2C are a flowchart of a charging method according to Embodiment 2 of the present invention;

FIG. 3A, FIG. 3B, and FIG. 3C are a flowchart of a charging method according to Embodiment 3 of the present invention;

FIG. 4A, FIG. 4B, and FIG. 4C are a flowchart of a charging method according to Embodiment 4 of the present invention;

FIG. 5 is a flowchart of a charging method according to Embodiment 5 of the present invention;

FIG. 6 is a flowchart of a charging method according to Embodiment 6 of the present invention;

FIG. 7 is a schematic structural diagram of a charging apparatus according to Embodiment 7 of the present invention;

FIG. 8 is a schematic structural diagram of a charging apparatus according to Embodiment 8 of the present invention;

FIG. 9 is a schematic structural diagram of a charging apparatus according to Embodiment 9 of the present invention;

FIG. 10 is a schematic structural diagram of a charging apparatus according to Embodiment 10 of the present invention;

FIG. 11 is a schematic structural diagram of a charging apparatus according to Embodiment 11 of the present invention; and

FIG. 12 is a schematic structural diagram of a charging apparatus according to Embodiment 12 of the present invention.

### DESCRIPTION OF EMBODIMENTS

To make the objectives, technical solutions, and advantages of the present invention clearer, the following further describes the embodiments of the present invention in detail with reference to the accompanying drawings.

### Embodiment 1

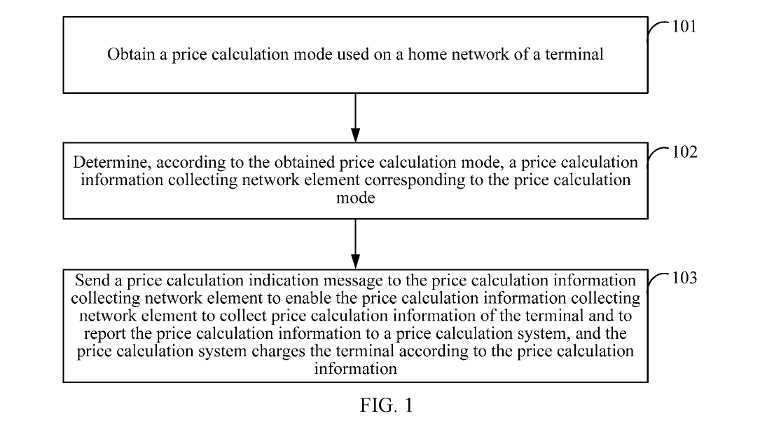

Referring to FIG. 1, this embodiment of the present invention provides a charging method, including:

Step 101: Obtain a mode of price calculation for the terminal used on a home network of a terminal.

Step 102: Determine, according to the obtained mode of price calculation for the terminal, a network collecting element corresponding to the mode of price calculation for the terminal.

Step 103: Send a price calculation indication message to the network collecting element, to enable the network collecting element to collect price calculation information of the terminal and reports the price calculation information to a price calculation system for calculating price for the terminal according to the price calculation information.

Preferably, the obtaining the mode of price calculation for the terminal used on a home network of a terminal includes:
receiving the mode of price calculation for the terminal that is used on the home network of the terminal and that is sent by a policy and charging enforcement function PCEF; or
receiving a terminal identifier sent by a PCEF, obtaining a network identifier of the home network of the terminal from the terminal identifier, and obtaining, according to the obtained network identifier and a stored correspondence between a network identifier and a mode of price calculation for the terminal, the mode of price calculation for the terminal used on the home network of the terminal.

Further, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

Preferably, the determining, according to the obtained mode of price calculation for the terminal, a network collecting element corresponding to the mode of price calculation for the terminal includes:
obtaining a type of a corresponding network collecting element according to the obtained mode of price calculation for the terminal and a stored correspondence between a mode of price calculation for the terminal and a type of a network collecting element, and determining the network collecting element corresponding to the obtained type as the network collecting element corresponding to the mode of price calculation for the terminal.

In this embodiment of the present invention, a mode of price calculation for the terminal used on a home network of a terminal is obtained; a network collecting element corresponding to the mode of price calculation for the terminal is determined according to the obtained mode of price calculation for the terminal; and a price calculation indication message is sent to the network collecting element, so that the network collecting element collects price calculation information of the terminal, and a price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 2

This embodiment of the present invention provides a charging method.

Currently, there are three modes of price calculation for the terminals for mobile communications, which are respectively: a PCEF (Policy and Charging Enforcement Function, policy and charging enforcement function)-based mode of price calculation for the terminal, a TDF (Traffic Detection Function, traffic detection function)-based mode of price calculation for the terminal, and an authentication authorization and accounting (AAA)-based mode of price calculation for the terminal. One mode of price calculation for the terminal is selected from the foregoing three mode of price calculation for the terminals on each network, and is used as a mode of price calculation for the terminal used on the network.

In a roaming scenario, a terminal roams from a home network of the terminal to a network of a visited location, and accesses the network of the visited location. In this case, a server of the visited location needs to determine whether the terminal is a roaming terminal and charge the roaming terminal by using this method.

In this embodiment of the present invention, an AAA determines whether the terminal is a roaming terminal, and if the terminal is a roaming terminal, obtains a mode of price calculation for the terminal used on the home network of the terminal.

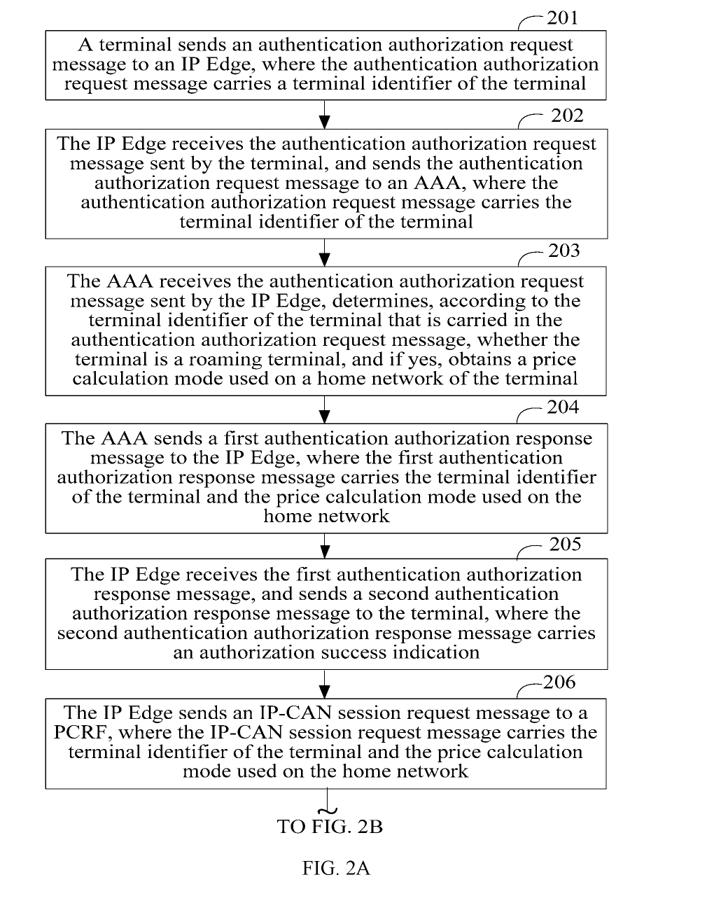

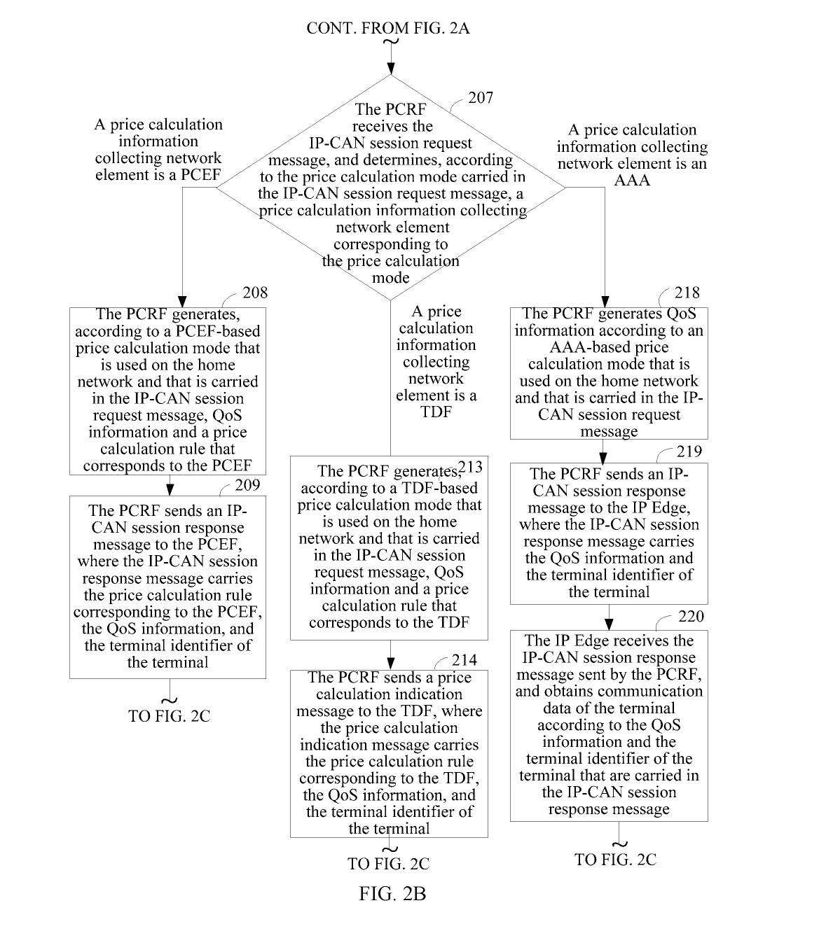

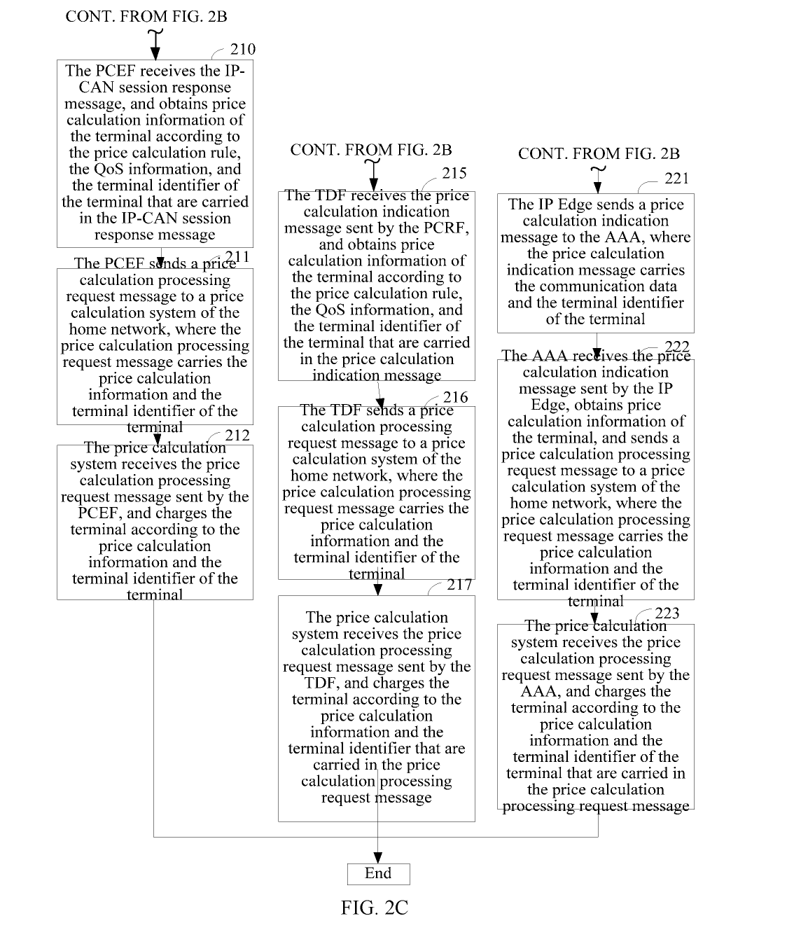

Referring to FIG. 2A, FIG. 2B, and FIG. 2C, the method includes:

Step 201: A terminal sends an authentication authorization request message to an IP Edge (Internet Protocol Edge, Internet Protocol Edge), where the authentication authorization request message carries a terminal identifier of the terminal.

The terminal identifier of the terminal includes at least a network identifier of the home network of the terminal.

Step 202: The IP Edge receives the authentication authorization request message sent by the terminal, and sends the authentication authorization request message to an AAA, where the authentication authorization request message carries the terminal identifier of the terminal.

Step 203: The AAA receives the authentication authorization request message sent by the IP Edge, determines, according to the terminal identifier of the terminal that is carried in the authentication authorization request message, whether the terminal is a roaming terminal, and if yes, obtains a mode of price calculation for the terminal used on a home network of the terminal.

Specifically, the AAA receives the authentication authorization request message sent by the IP Edge, obtains the network identifier of the home network of the terminal from the terminal identifier of the terminal that is carried in the authentication authorization request message, and compares the network identifier of the home network of the terminal with a stored network identifier of a local network, and if the network identifiers are different, the AAA determines that the terminal is a roaming terminal. The mode of price calculation for the terminal used on the home network of the terminal is obtained according to the network identifier of the home network of the terminal and a stored correspondence between a network identifier and a mode of price calculation for the terminal.

The AAA obtains in advance a network identifier of each operator network and a mode of price calculation for the terminal used on the network, and stores, according to the correspondence between a network identifier and a mode of price calculation for the terminal, the obtained network identifier of each operator network and the obtained mode of price calculation for the terminal used on the network.

If it is obtained by means of comparison that the network identifier of the home network of the terminal is the same as the stored network identifier of the local network, it is determined that the terminal is not a roaming terminal, and the terminal is directly charged by using a mode of price calculation for the terminal used on the local network.

Step 204: The AAA sends a first authentication authorization response message to the IP Edge, where the first authentication authorization response message carries the terminal identifier of the terminal and the mode of price calculation for the terminal used on the home network.

Step 205: The IP Edge receives the first authentication authorization response message, and sends a second authentication authorization response message to the terminal, where the second authentication authorization response message carries an authorization success indication.

Step 206: The IP Edge sends an IP-CAN (IP-Connectivity Access Network, Internet Protocol-connectivity access network) session request message to a PCRF, where the IP-CAN session request message carries the terminal identifier of the terminal and the mode of price calculation for the terminal used on the home network.

Step 207: The PCRF receives the IP-CAN session request message sent by the IP Edge, and determines, according to the mode of price calculation for the terminal carried in the IP-CAN session request message, a network collecting element corresponding to the mode of price calculation for the terminal.

Different modes of price calculation for the terminals correspond to different network collecting elements, where a network collecting element corresponding to the PCEF-based mode of price calculation for the terminal is a PCEF, a network collecting element corresponding to the TDF-based mode of price calculation for the terminal is a TDF, and a network collecting element corresponding to the AAA-based mode of price calculation for the terminal is an AAA.

This step is specifically: receiving, by the PCRF, the IP-CAN session request message sent by the IP Edge, obtaining a type of a corresponding network collecting element according to the mode of price calculation for the terminal carried in the IP-CAN session request message and a stored correspondence between a mode of price calculation for the terminal and a type of a network collecting element, and determining the network collecting element corresponding to the obtained type as the network collecting element corresponding to the mode of price calculation for the terminal.

If the PCRF determines that the network collecting element corresponding to the mode of price calculation for the terminal is a PCEF, perform step 208, if the PCRF determines that the network collecting element corresponding to the mode of price calculation for the terminal is a TDF, perform step 213, and if the PCRF determines that the network collecting element corresponding to the mode of price calculation for the terminal is an AAA, perform step 218.

Step 208: The PCRF generates, according to the PCEF-based mode of price calculation for the terminal that is used on the home network and that is carried in the IP-CAN session request message, QoS (Quality of Service, quality of service) information and a price calculation rule that corresponds to a PCEF.

The QoS information is indication information used to indicate a bandwidth that ensures normal communication of the terminal. The price calculation rule may include a charging key (charging key, charging key), and is used to determine a charging standard in a price calculation system, for example, a fee for each short message service message and a fee for each minute of call duration.

Step 209: The PCRF sends an IP-CAN session response message to the PCEF, where the IP-CAN session response message carries the price calculation rule corresponding to the PCEF, the QoS information, and the terminal identifier of the terminal.

Step 210: The PCEF receives the IP-CAN session response message, and obtains price calculation information of the terminal according to the price calculation rule, the QoS information, and the terminal identifier of the terminal that are carried in the IP-CAN session response message.

Specifically, the PCEF receives the IP-CAN session response message sent by the PCRF, and provides, according to the QoS information and the terminal identifier that are carried in the IP-CAN session response message, a bandwidth specified in the QoS information to the terminal corresponding to the terminal identifier, to ensure normal communication of the terminal. The PCEF detects and records communication data of the terminal in real time, and obtains the price calculation information of the terminal according to the recorded communication data and the received price calculation rule.

Step 211: The PCEF sends a charging processing request message to a price calculation system of the home network, where the charging processing request message carries the price calculation information and the terminal identifier of the terminal.

The PCEF obtains the network identifier of the home network of the terminal from the terminal identifier of the terminal, and sends the charging processing request message to the price calculation system of the home network according to the network identifier of the home network of the terminal, where the charging processing request message carries the price calculation information and the terminal identifier of the terminal, so that the price calculation system charges the terminal according to the price calculation information and the terminal identifier of the terminal.

Step 212: The price calculation system receives the charging processing request message sent by the PCEF, and charges the terminal according to the price calculation information and the terminal identifier of the terminal, and the procedure ends.

Specifically, the price calculation system receives the charging processing request message sent by the PCEF, determines, according to the price calculation information carried in the charging processing request message, a total fee that the terminal needs to be charged, and then charges the terminal the determined total fee according to the terminal identifier carried in the charging processing request message.

Step 213: The PCRF generates, according to a TDF-based mode of price calculation for the terminal that is used on the home network and that is carried in the IP-CAN session request message, QoS information and a price calculation rule that corresponds to a TDF.

Step 214: The PCRF sends a price calculation indication message to the TDF, where the price calculation indication message carries the price calculation rule corresponding to the TDF, the QoS information, and the terminal identifier of the terminal.

Step 215: The TDF receives the price calculation indication message sent by the PCRF, and obtains price calculation information of the terminal according to the price calculation rule, the QoS information, and the terminal identifier of the terminal that are carried in the price calculation indication message.

Specifically, the TDF receives the price calculation indication message sent by the PCRF, and provides, according to the QoS information and the terminal identifier of the terminal that are carried in the price calculation indication message, a bandwidth specified in the QoS information to the terminal, to ensure normal communication of the terminal. The TDF detects and records communication data of the terminal in real time, and obtains the price calculation information of the terminal according to the recorded communication data and the received price calculation rule.

Step 216: The TDF sends a charging processing request message to a price calculation system of the home network, where the charging processing request message carries the price calculation information and the terminal identifier of the terminal.

The TDF obtains the network identifier of the home network of the terminal from the terminal identifier of the terminal, and sends the charging processing request message to the price calculation system of the home network according to the network identifier of the home network of the terminal, where the charging processing request message carries the price calculation information and the terminal identifier of the terminal, so that the price calculation system charges the terminal according to the price calculation information and the terminal identifier of the terminal.

Step 217: The price calculation system receives the charging processing request message sent by the TDF, and charges the terminal according to the price calculation information and the terminal identifier that are carried in the charging processing request message, and the procedure ends.

Specifically, the price calculation system receives the charging processing request message sent by the TDF, determines, according to the price calculation information carried in the charging processing request message, a total fee that the terminal needs to be charged, and then charges the terminal the determined total fee according to the terminal identifier carried in the charging processing request message.

Step 218: The PCRF generates QoS information according to an AAA-based mode of price calculation for the terminal that is used on the home network and that is carried in the IP-CAN session request message.

Step 219: The PCRF sends an IP-CAN session response message to the IP Edge, where the IP-CAN session response message carries the QoS information and the terminal identifier of the terminal.

Step 220: The IP Edge receives the IP-CAN session response message sent by the PCRF, and obtains communication data of the terminal according to the QoS information and the terminal identifier of the terminal that are carried in the IP-CAN session response message.

Specifically, the IP Edge receives the IP-CAN session response message sent by the PCRF, provides, according to the QoS information and the terminal identifier of the terminal that are carried in the IP-CAN session response message, a bandwidth specified in the QoS information to the terminal, to ensure normal communication of the terminal, and detects and records communication data of the terminal in real time.

Step 221: The IP Edge sends a price calculation indication message to the AAA, where the price calculation indication message carries the communication data and the terminal identifier of the terminal.

Step 222: The AAA receives the price calculation indication message sent by the IP Edge, obtains price calculation information of the terminal, and sends a charging processing request message to a price calculation system of the home network, where the charging processing request message carries the price calculation information and the terminal identifier of the terminal.

The AAA receives the price calculation indication message sent by the IP Edge, obtains a price calculation rule stored in the AAA, obtains the price calculation information of the terminal according to the communication data carried in the price calculation indication message and the obtained price calculation rule, obtains the network identifier of the home network of the terminal from the terminal identifier carried in the price calculation indication message, and sends the charging processing request message to the price calculation system of the home network according to the obtained network identifier, where the charging processing request message carries the price calculation information and the terminal identifier of the terminal, so that the price calculation system charges the terminal according to the price calculation information of the terminal and the terminal identifier.

Step 223: The price calculation system receives the charging processing request message sent by the AAA, and charges the terminal according to the price calculation information and the terminal identifier of the terminal that are carried in the charging processing request message, and the procedure ends.

Specifically, the price calculation system receives the charging processing request message sent by the AAA, determines, according to the price calculation information carried in the charging processing request message, a total fee that the terminal needs to be charged, and then charges the terminal the determined total fee according to the terminal identifier carried in the charging processing request message.

In this embodiment of the present invention, the PCEF and the IP Edge are a same network element, and when the network element is used as the network collecting element, the network element is referred to as the PCEF.

In this embodiment of the present invention, a mode of price calculation for the terminal used on a home network of a terminal is obtained; a network collecting element corresponding to the mode of price calculation for the terminal is determined according to the obtained mode of price calculation for the terminal; and a price calculation indication message is sent to the network collecting element, so that the network collecting element collects price calculation information of the terminal, and a price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 3

This embodiment of the present invention provides a charging method.

Currently, there are three modes of price calculation for the terminals for mobile communications, which are respectively: a PCEF-based mode of price calculation for the terminal, a TDF-based mode of price calculation for the terminal, and an AAA-based mode of price calculation for the terminal. One mode of price calculation for the terminal is selected from the foregoing three modes of price calculation for the terminals on each network, and is used as a mode of price calculation for the terminal used on the network.

In a roaming scenario, a terminal roams from a home network of the terminal to a network of a visited location, and accesses the network of the visited location. In this case, a server of the visited location needs to determine whether the terminal is a roaming terminal and charge the roaming terminal online by using this method.

In this embodiment of the present invention, an AAA determines whether a terminal is a roaming terminal; and if the terminal is a roaming terminal, the AAA obtains a mode of price calculation for the terminal used on a home network of the terminal and determines whether the mode of price calculation for the terminal is the AAA-based mode of price calculation for the terminal. If the mode of price calculation for the terminal is not the AAA-based mode of price calculation for the terminal, the PCRF obtains the mode of price calculation for the terminal used on the home network of the terminal and determines whether the mode of price calculation for the terminal used on the home network of the terminal is a PCEF-based or a TDF-based mode of price calculation for the terminal.

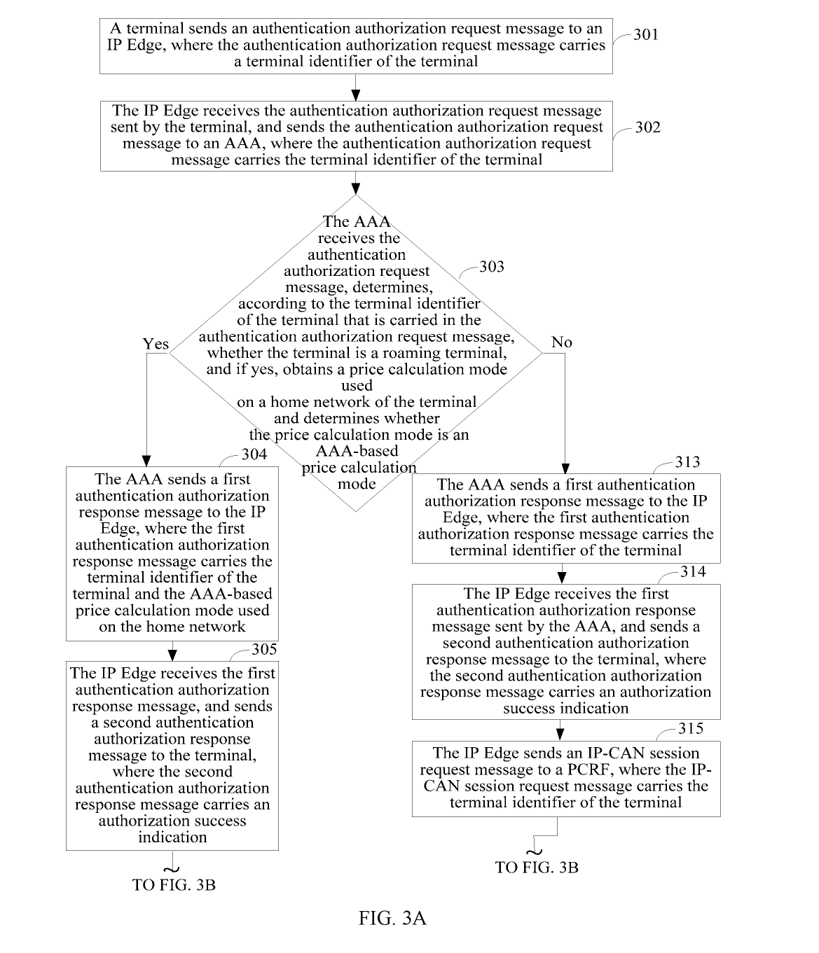

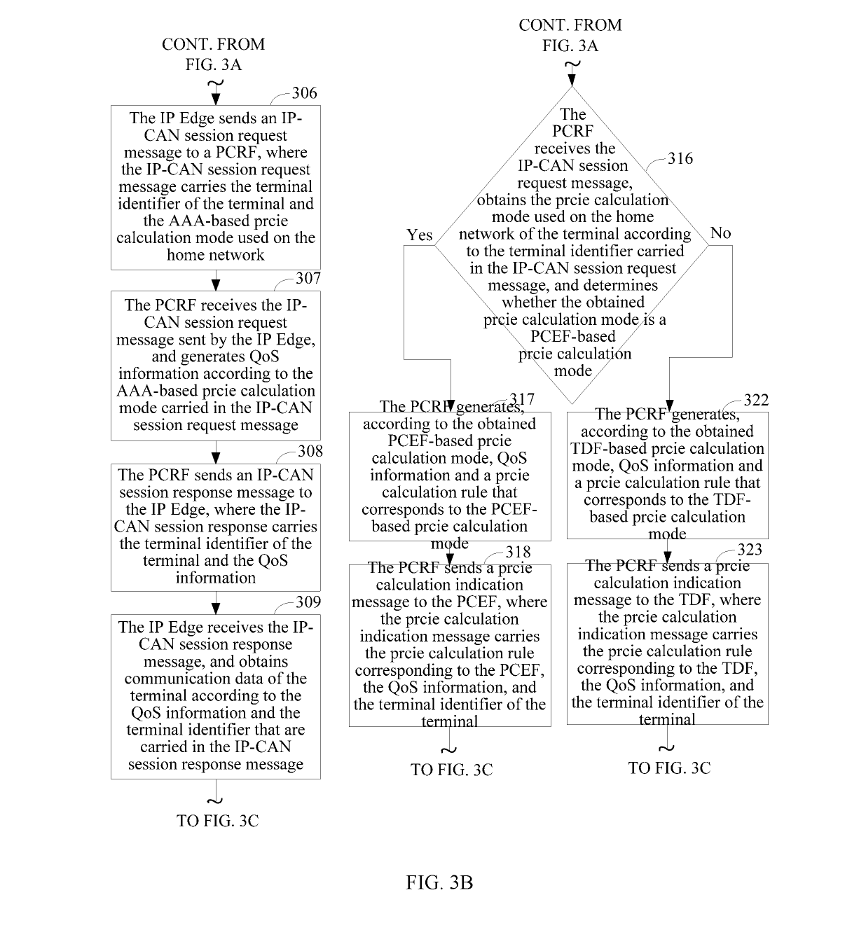

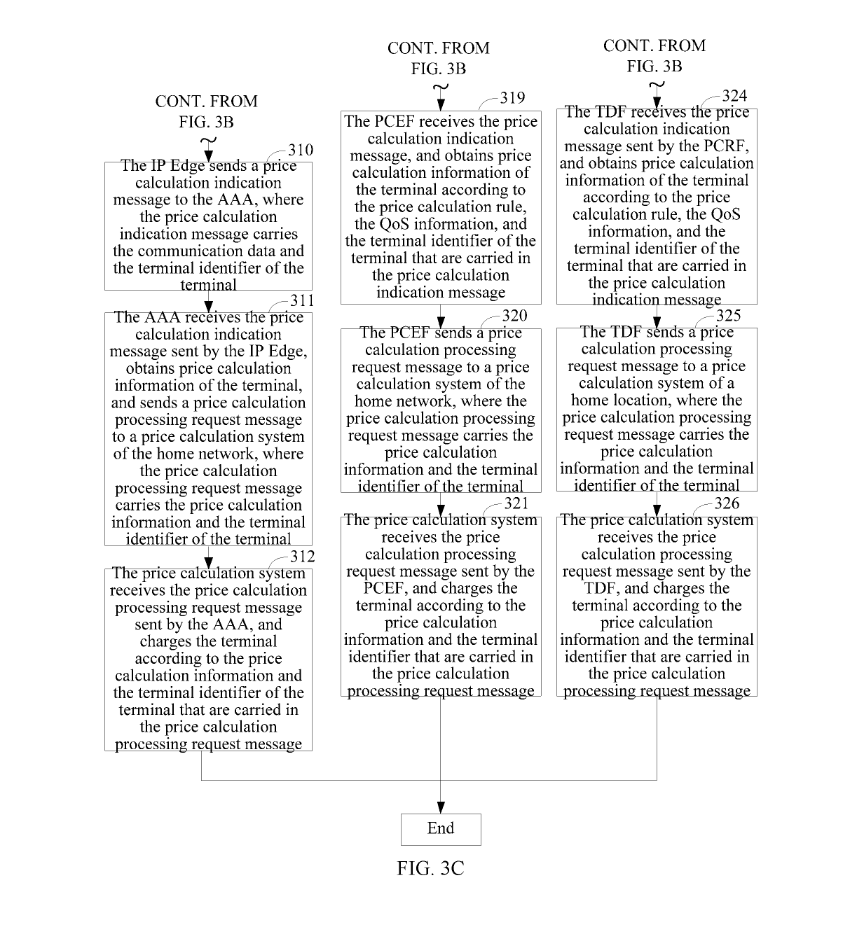

Referring to FIG. 3A, FIG. 3B, and FIG. 3C, the method includes:

Step 301: A terminal sends an authentication authorization request message to an IP Edge, where the authentication authorization request message carries a terminal identifier of the terminal.

The terminal identifier of the terminal includes at least a network identifier of the home network of the terminal.

Step 302: The IP Edge receives the authentication authorization request message sent by the terminal, and sends the authentication authorization request message to an AAA, where the authentication authorization request message carries the terminal identifier of the terminal.

Step 303: The AAA receives the authentication authorization request message sent by the IP Edge, determines, according to the terminal identifier of the terminal that is carried in the authentication authorization request message, whether the terminal is a roaming terminal, and if yes, obtains a mode of price calculation for the terminal used on a home network of the terminal and determines whether the mode of price calculation for the terminal is an AAA-based mode of price calculation for the terminal; and if yes, performs step 304; or if not, performs step 313.

Specifically, the AAA receives the authentication authorization request message sent by the IP Edge, obtains the network identifier of the home network of the terminal from the terminal identifier of the terminal that is carried in the authentication authorization request message, and compares the network identifier of the home network of the terminal with a stored network identifier of a local network, and if the network identifiers are different, the AAA determines that the terminal is a roaming terminal. The mode of price calculation for the terminal used on the home network is obtained according to the network identifier of the home network of the terminal and a stored correspondence between a network identifier and a mode of price calculation for the terminal, and it is determined whether the obtained mode of price calculation for the terminal is the AAA-based mode of price calculation for the terminal; and if yes, step 304 is performed; or if not, step 313 is performed.

The AAA obtains in advance a network identifier of each operator network and a mode of price calculation for the terminal used on the network, and stores, according to the correspondence between a network identifier and a mode of price calculation for the terminal, the obtained network identifier of each operator network and the obtained mode of price calculation for the terminal used on the network.

If it is obtained by means of comparison that the network identifier of the home network of the terminal is the same as the stored network identifier of the local network, it is determined that the terminal is not a roaming terminal, and the terminal is directly charged by using a mode of price calculation for the terminal used on the local network.

Step 304: The AAA sends a first authentication authorization response message to the IP Edge, where the first authentication authorization response message carries the terminal identifier of the terminal and the AAA-based mode of price calculation for the terminal used on the home network.

Step 305: The IP Edge receives the first authentication authorization response message, and sends a second authentication authorization response message to the terminal, where the second authentication authorization response message carries an authorization success indication.

Step 306: The IP Edge sends an IP-CAN session request message to a PCRF, where the IP-CAN session request message carries the terminal identifier of the terminal and the AAA-based mode of price calculation for the terminal used on the home network.

Step 307: The PCRF receives the IP-CAN session request message sent by the IP Edge, and generates QoS information according to the AAA-based mode of price calculation for the terminal carried in the IP-CAN session request message.

The QoS information is indication information used to indicate a bandwidth that ensures normal communication of the terminal. The price calculation rule may include a charging key (charging key, charging key), and is used to determine a charging standard in a price calculation system, for example, a fee for each piece of information and a fee for each minute of call duration.

Step 308: The PCRF sends an IP-CAN session response message to the IP Edge, where the IP-CAN session response message carries the terminal identifier of the terminal and the QoS information.

Step 309: The IP Edge receives the IP-CAN session response message sent by the PCRF, and obtains communication data of the terminal according to the QoS information and the terminal identifier that are carried in the IP-CAN session response message.

Specifically, the IP Edge receives the IP-CAN session response message sent by the PCRF, and provides, according to the QoS information and the terminal identifier that are carried in the IP-CAN session response message, a bandwidth specified in the QoS information to the terminal, to ensure normal communication of the terminal. The IP Edge detects and records communication data of the terminal in real time.

Step 310: The IP Edge sends a price calculation indication message to the AAA, where the price calculation indication message carries the communication data and the terminal identifier of the terminal.

Step 311: The AAA receives the price calculation indication message sent by the IP Edge, obtains price calculation information of the terminal, and sends a charging processing request message to a price calculation system of the home network, where the charging processing request message carries the price calculation information and the terminal identifier of the terminal.

The AAA receives the price calculation indication message sent by the IP Edge, obtains a price calculation rule stored in the AAA, obtains the price calculation information of the terminal according to the obtained price calculation rule and the communication data of the terminal that is carried in the price calculation indication message, sends the charging processing request message to the price calculation system of the home network according to the network identifier of the home network that is carried in the price calculation indication message, where the charging processing request message carries the price calculation information and the terminal identifier of the terminal, so that the price calculation system charges the terminal according to the price calculation information and the terminal identifier of the terminal.

For the AAA-based mode of price calculation for the terminal, the AAA itself stores the price calculation rule corresponding to this mode of price calculation for the terminal.

Step 312: The price calculation system receives the charging processing request message sent by the AAA, and charges the terminal according to the price calculation information and the terminal identifier of the terminal that are carried in the charging processing request message, and the procedure ends.

Specifically, the price calculation system receives the charging processing request message sent by the AAA, determines, according to the price calculation information carried in the charging processing request message, a total fee that the terminal needs to be charged, and then charges the terminal the determined total fee according to the terminal identifier carried in the charging processing request message.

Step 313: The AAA sends a first authentication authorization response message to the IP Edge, where the first authentication authorization response message carries the terminal identifier of the terminal.

Further, the first authentication authorization response message may further carry a roaming indication, where the roaming indication is used to indicate that the terminal is a roaming terminal.

Step 314: The IP Edge receives the first authentication authorization response message sent by the AAA, and sends a second authentication authorization response message to the terminal, where the second authentication authorization response message carries an authorization success indication.

Step 315: The IP Edge sends an IP-CAN session request message to a PCRF, where the IP-CAN session request message carries the terminal identifier of the terminal.

Further, the IP-CAN session request message may further carry a roaming charging indication, so that the PCRF determines, according to the roaming indication, that the terminal is a roaming terminal.

Step 316: The PCRF receives the IP-CAN session request message sent by the IP Edge, obtains, according to the terminal identifier carried in the IP-CAN session request message, the mode of price calculation for the terminal used on the home network of the terminal, and determines whether the obtained mode of price calculation for the terminal is a PCEF-based mode of price calculation for the terminal; and if yes, performs step 317; or if not, performs step 322.

Specifically, the PCRF receives the IP-CAN session request message sent by the IP Edge, obtains the network identifier of the home network of the terminal from the terminal identifier carried in the IP-CAN session request message, obtains, according to the obtained network identifier and a stored correspondence between a network identifier and a mode of price calculation for the terminal, the mode of price calculation for the terminal used on the home network of the terminal, and determines whether the obtained mode of price calculation for the terminal is a PCEF-based mode of price calculation for the terminal; and if yes, performs step 317; or if not, the mode of price calculation for the terminal used on the home network is a TDF-based mode of price calculation for the terminal, and the PCRF performs step 322.

The PCRF obtains in advance a network identifier of each operator network and a mode of price calculation for the terminal used on the network, and stores, according to the correspondence between a network identifier and a mode of price calculation for the terminal, the obtained network identifier of each operator network and the obtained mode of price calculation for the terminal used on the network.

Further, if the IP-CAN session request message does not carry a roaming indication used to indicate that the terminal is a roaming terminal, after receiving the IP-CAN session request message sent by the IP Edge, the PCRF first needs to determine, according to the terminal identifier carried in the IP-CAN session request message, whether the terminal is a roaming terminal. A specific determining process is:
obtaining, by the PCRF, the network identifier of the home network of the terminal from the terminal identifier carried in the IP-CAN session request message, and comparing the obtained network identifier with a stored network identifier of a local network, and if the network identifiers are different, determining that the terminal is a roaming terminal.

Step 317: The PCRF generates, according to the obtained PCEF-based mode of price calculation for the terminal, QoS information and a price calculation rule that corresponds to the PCEF-based mode of price calculation for the terminal.

Step 318: The PCRF sends a price calculation indication message to the PCEF, where the price calculation indication message carries the price calculation rule corresponding to the PCEF, the QoS information, and the terminal identifier of the terminal.

Step 319: The PCEF receives the price calculation indication message sent by the PCRF, and obtains price calculation information of the terminal according to the price calculation rule, the QoS information, and the terminal identifier of the terminal that are carried in the price calculation indication message.

Specifically, the PCEF receives the price calculation indication message sent by the PCRF, and provides, according to the QoS information and the terminal identifier of the terminal that are carried in the price calculation indication message, a bandwidth specified in the QoS information to the terminal corresponding to the terminal identifier, to ensure normal communication of the terminal. The PCEF detects and records communication data of the terminal in real time, and obtains the price calculation information of the terminal according to the recorded communication data and the price calculation rule that is carried in the price calculation indication message.

Step 320: The PCEF sends a charging processing request message to a price calculation system of the home network, where the charging processing request message carries the price calculation information and the terminal identifier of the terminal.

The PCEF obtains the network identifier of the home network of the terminal from the terminal identifier carried in the price calculation indication message, and sends the charging processing request message to the price calculation system of the home network according to the obtained network identifier, where the charging processing request message carries the price calculation information and the terminal identifier of the terminal, so that the price calculation system charges the terminal according to the price calculation information and the terminal identifier of the terminal.

Step 321: The price calculation system receives the charging processing request message sent by the PCEF, and charges the terminal according to the price calculation information and the terminal identifier that are carried in the charging processing request message, and the procedure ends.

Specifically, the price calculation system receives the charging processing request message sent by the PCEF, determines, according to the price calculation information carried in the charging processing request message, a total fee that the terminal needs to be charged, and then charges the terminal the determined total fee according to the terminal identifier carried in the charging processing request message.

Step 322: The PCRF generates, according to the obtained TDF-based mode of price calculation for the terminal, QoS information and a price calculation rule that corresponds to the TDF-based mode of price calculation for the terminal.

Step 323: The PCRF sends a price calculation indication message to the TDF, where the price calculation indication message carries the price calculation rule corresponding to the TDF, the QoS information, and the terminal identifier of the terminal.

Step 324: The TDF receives the price calculation indication message sent by the PCRF, and obtains price calculation information of the terminal according to the price calculation rule, the QoS information, and the terminal identifier of the terminal that are carried in the price calculation indication message.

Specifically, the TDF receives the price calculation indication message sent by the PCRF, and provides, according to the QoS information and the terminal identifier of the terminal that are carried in the price calculation indication message, a bandwidth specified in the QoS information to the terminal, to ensure normal communication of the terminal. The TDF detects and records communication data of the terminal in real time, and obtains the price calculation information of the terminal according to the recorded communication data and the price calculation rule that is carried in the price calculation indication message.

Step 325: The TDF sends a charging processing request message to a price calculation system of the home network, where the charging processing request message carries the price calculation information and the terminal identifier of the terminal.

The TDF obtains the network identifier of the home network of the terminal from the terminal identifier carried in the price calculation indication message, and sends the charging processing request message to the price calculation system of the home network according to the obtained network identifier, where the charging processing request message carries the price calculation information and the terminal identifier of the terminal, so that the price calculation system charges the terminal according to the price calculation information and the terminal identifier of the terminal.

Step 326: The price calculation system receives the charging processing request message sent by the TDF, and charges the terminal according to the price calculation information and the terminal identifier that are carried in the charging processing request message, and the procedure ends.

Specifically, the price calculation system receives the charging processing request message sent by the TDF, determines, according to the price calculation information carried in the charging processing request message, a total fee that the terminal needs to be charged, and then charges the terminal the determined total fee according to the terminal identifier carried in the charging processing request message.

Further, in step 304, the first authentication authorization response message may not directly carry the AAA-based mode of price calculation for the terminal used on the home network, and may indicate implicitly that the AAA-based mode of price calculation for the terminal is used on the home network, which may be specifically:
after determining that the AAA-based mode of price calculation for the terminal is used on the home network, the AAA obtains a price calculation rule that corresponds to the AAA-based mode of price calculation for the terminal and that is stored in the AAA, and then sends the first authentication authorization response message to the IP Edge, where the first authentication authorization response message carries the terminal identifier of the terminal and the obtained price calculation rule. After receiving the first authentication authorization response message, the IP Edge determines, according to the price calculation rule carried in the first authentication authorization response message, that the mode of price calculation for the terminal used on the home network is the AAA-based mode of price calculation for the terminal, provides, according to the QoS information carried in the first authentication authorization response message, a bandwidth specified in the QoS information to the terminal, to ensure normal communication of the terminal, and detects and records communication data of the terminal in real time. Then, the IP Edge sends the recorded communication data to the AAA, and the AAA obtains the price calculation information of the terminal according to the communication data sent by the IP Edge and the price calculation rule stored in the AAA.

In this embodiment of the present invention, the PCEF and the IP Edge are a same network element, and when the network element is used as the network collecting element, the network element is referred to as the PCEF.

In this embodiment of the present invention, a mode of price calculation for the terminal used on a home network of a terminal is obtained; a network collecting element corresponding to the mode of price calculation for the terminal is determined according to the obtained mode of price calculation for the terminal; and a price calculation indication message is sent to the network collecting element, so that the network collecting element obtains price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 4

This embodiment of the present invention provides a charging method.

Currently, there are three modes of price calculation for the terminals for mobile communications, which are respectively: a PCEF-based mode of price calculation for the terminal, a TDF-based mode of price calculation for the terminal, and an AAA-based mode of price calculation for the terminal. One mode of price calculation for the terminal is selected from the foregoing three mode of price calculation for the terminals on each network, and is used as a mode of price calculation for the terminal used on the network.

In a roaming scenario, a terminal roams from a home network of the terminal to a network of a visited location, and accesses the network of the visited location. In this case, a server of the visited location needs to determine whether the terminal is a roaming terminal and charge the roaming terminal by using this method.

In this embodiment of the present invention, an IP Edge determines whether the terminal is a roaming terminal, and determines whether a mode of price calculation for the terminal used on a home network of the terminal is a PCEF-based mode of price calculation for the terminal or an AAA-based mode of price calculation for the terminal; and if not, a PCRF determines whether the mode of price calculation for the terminal used on the home network of the terminal is a TDF-based mode of price calculation for the terminal.

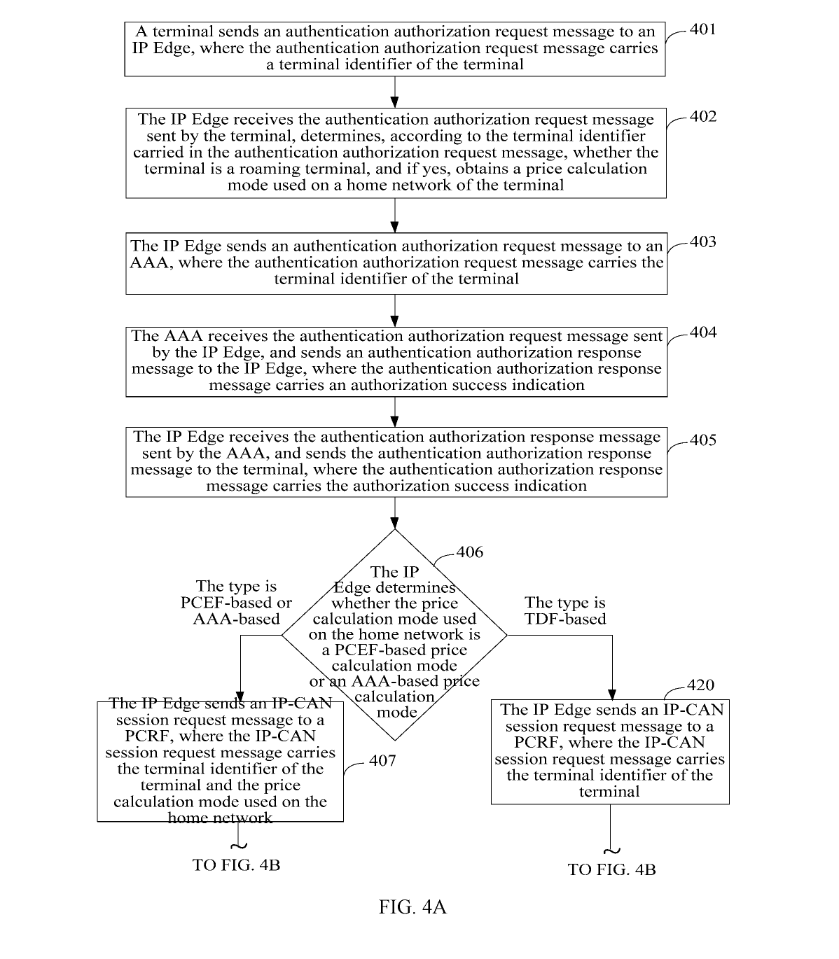

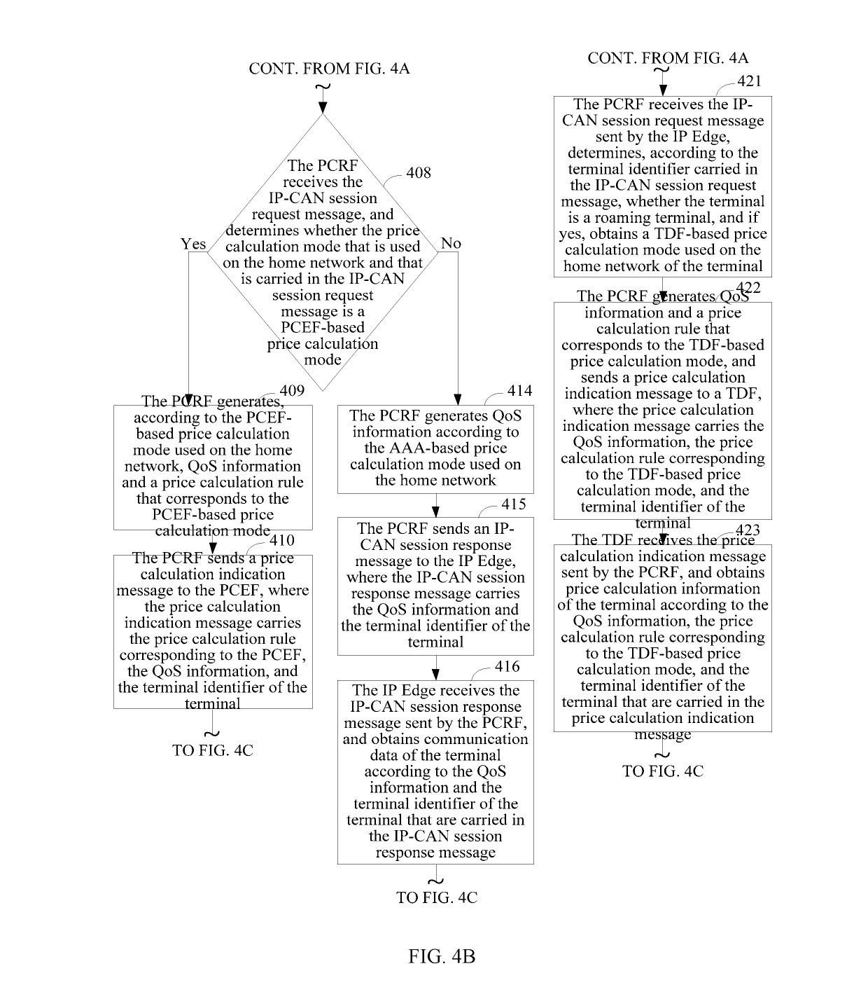

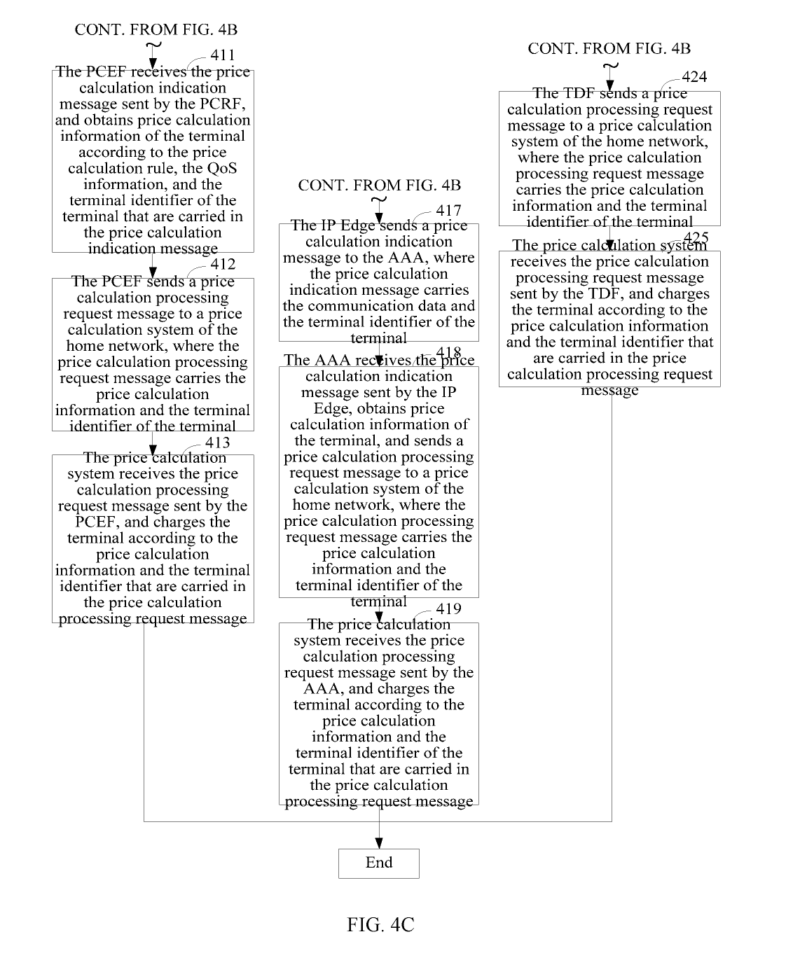

Referring to FIG. 4A, FIG. 4B, and FIG. 4C, the method includes:

Step 401: A terminal sends an authentication authorization request message to an IP Edge, where the authentication authorization request message carries a terminal identifier of the terminal.

The terminal identifier of the terminal includes at least a network identifier of the home network of the terminal.

Step 402: The IP Edge receives the authentication authorization request message sent by the terminal, determines, according to the terminal identifier carried in the authentication authorization request message, whether the terminal is a roaming terminal, and if yes, obtains a mode of price calculation for the terminal used on a home network of the terminal.

Specifically, the IP Edge receives the authentication authorization request message sent by the terminal, obtains the network identifier of the home network of the terminal from the terminal identifier carried in the authentication authorization request message, compares the obtained network identifier with a stored network identifier of a local network, and if the network identifiers are different, determines that the terminal is a roaming terminal. The mode of price calculation for the terminal used on the home network of the terminal is obtained according to the network identifier of the home network of the terminal and a stored correspondence between a network identifier and a mode of price calculation for the terminal.

The IP Edge obtains in advance a network identifier of each operator network and a mode of price calculation for the terminal used on the network, and stores, according to the correspondence between a network identifier and a mode of price calculation for the terminal, the obtained network identifier of each operator network and the obtained mode of price calculation for the terminal used on the network.

If it is obtained by means of comparison that the network identifier of the home network of the terminal is the same as the stored network identifier of the local network, it is determined that the terminal is not a roaming terminal, and the terminal is directly charged by using a mode of price calculation for the terminal used on the local network.

While determining whether the terminal is a roaming terminal, the IP Edge further needs to perform authentication authorization on the terminal by means of operations in the following steps 403 to 405.

Step 403: The IP Edge sends an authentication authorization request message to an AAA, where the authentication authorization request message carries the terminal identifier of the terminal.

Step 404: The AAA receives the authentication authorization request message sent by the IP Edge, and sends an authentication authorization response message to the IP Edge, where the authentication authorization response message carries an authorization success indication.

Step 405: The IP Edge receives the authentication authorization response message sent by the AAA, and sends the authentication authorization response message to the terminal, where the authentication authorization response message carries the authorization success indication.

After determining that the terminal is a roaming terminal and obtaining the mode of price calculation for the terminal used on the home network of the terminal, the IP Edge needs to determine, by using the following step 406, a type of the mode of price calculation for the terminal used on the home network.

Step 406: The IP Edge performs determining on the obtained mode of price calculation for the terminal used on the home network; and if the mode of price calculation for the terminal is a PCEF-based mode of price calculation for the terminal or an AAA-based mode of price calculation for the terminal, performs step 407; otherwise, performs step 420.

If the IP Edge determines that the obtained mode of price calculation for the terminal used on the home network is a PCEF-based mode of price calculation for the terminal or an AAA-based mode of price calculation for the terminal, performs step 407; otherwise, if the IP Edge determines that the mode of price calculation for the terminal used on the home network is a TDF-based mode of price calculation for the terminal, performs an operation of step 420.

Step 407: The IP Edge sends an IP-CAN session request message to a PCRF, where the IP-CAN session request message carries the terminal identifier of the terminal and the mode of price calculation for the terminal used on the home network.

Step 408: The PCRF receives the IP-CAN session request message sent by the IP Edge, and determines the mode of price calculation for the terminal that is used on the home network and that is carried in the IP-CAN session request message; and if the mode of price calculation for the terminal is a PCEF-based mode of price calculation for the terminal, performs step 409; otherwise, if the mode of price calculation for the terminal is an AAA-based mode of price calculation for the terminal, performs step 414.

Step 409: The PCRF generates, according to the PCEF-based mode of price calculation for the terminal used on the home network, QoS information and a price calculation rule that corresponds to the PCEF-based mode of price calculation for the terminal.

Step 410: The PCRF sends a price calculation indication message to the PCEF, where the price calculation indication message carries the price calculation rule corresponding to the PCEF, the QoS information, and the terminal identifier of the terminal.

Step 411: The PCEF receives the price calculation indication message sent by the PCRF, and obtains price calculation information of the terminal according to the price calculation rule, the QoS information, and the terminal identifier of the terminal that are carried in the price calculation indication message.

Specifically, the PCEF receives the price calculation indication message sent by the PCRF, and provides, according to the QoS information and the terminal identifier of the terminal that are carried in the price calculation indication message, a bandwidth specified in the QoS information to the terminal corresponding to the terminal identifier, to ensure normal communication of the terminal. The PCEF detects and records communication data of the terminal in real time, and obtains the price calculation information of the terminal according to the recorded communication data and the price calculation rule that is carried in the price calculation indication message.

Step 412: The PCEF sends a charging processing request message to a price calculation system of the home network, where the charging processing request message carries the price calculation information and the terminal identifier of the terminal.

The PCEF obtains the network identifier of the home network of the terminal from the terminal identifier carried in the price calculation indication message, and sends the charging processing request message to the price calculation system of the home network according to the obtained network identifier, where the charging processing request message carries the price calculation information and the terminal identifier of the terminal, so that the price calculation system charges the terminal according to the price calculation information and the terminal identifier of the terminal.

Step 413: The price calculation system receives the charging processing request message sent by the PCEF, and charges the terminal according to the price calculation information and the terminal identifier that are carried in the charging processing request message, and the procedure ends.

Specifically, the price calculation system receives the charging processing request message sent by the PCEF, determines, according to the price calculation information carried in the charging processing request message, a total fee that the terminal needs to be charged, and then charges the terminal the determined total fee according to the terminal identifier carried in the charging processing request message.

Step 414: The PCRF generates QoS information according to the AAA-based mode of price calculation for the terminal used on the home network.

Step 415: The PCRF sends an IP-CAN session response message to the IP Edge, where the IP-CAN session response message carries the QoS information and the terminal identifier of the terminal.

Step 416: The IP Edge receives the IP-CAN session response message sent by the PCRF, and obtains communication data of the terminal according to the QoS information and the terminal identifier of the terminal that are carried in the IP-CAN session response message.

Specifically, the IP Edge receives the IP-CAN session response message sent by the PCRF, and provides, according to the QoS information carried in the IP-CAN session response message, a bandwidth specified in the QoS information to the terminal, to ensure normal communication of the terminal. The IP Edge detects and records communication data of the terminal in real time.

Step 417: The IP Edge sends a price calculation indication message to the AAA, where the price calculation indication message carries the communication data and the terminal identifier of the terminal.

Step 418: The AAA receives the price calculation indication message sent by the IP Edge, obtains price calculation information of the terminal, and sends a charging processing request message to a price calculation system of the home network, where the charging processing request message carries the price calculation information and the terminal identifier of the terminal.

The AAA receives the price calculation indication message sent by the IP Edge, obtains a price calculation rule stored in the AAA, obtains the price calculation information of the terminal according to the communication data carried in the price calculation indication message and the obtained price calculation rule, obtains the network identifier of the home network of the terminal from the terminal identifier carried in the price calculation indication message, and sends the charging processing request message to the price calculation system of the home network according to the obtained network identifier, where the charging processing request message carries the price calculation information and the terminal identifier of the terminal, so that the price calculation system charges the terminal according to the price calculation information of the terminal and the terminal identifier of the terminal.

Step 419: The price calculation system receives the charging processing request message sent by the AAA, and charges the terminal according to the price calculation information and the terminal identifier of the terminal that are carried in the charging processing request message, and the procedure ends.

Specifically, the price calculation system receives the charging processing request message sent by the AAA, determines, according to the price calculation information carried in the charging processing request message, a total fee that the terminal needs to be charged, and then charges the terminal the determined total fee according to the terminal identifier carried in the charging processing request message.

Step 420: The IP Edge sends an IP-CAN session request message to a PCRF, where the IP-CAN session request message carries the terminal identifier of the terminal.

Step 421: The PCRF receives the IP-CAN session request message sent by the IP Edge, determines, according to the terminal identifier carried in the IP-CAN session request message, whether the terminal is a roaming terminal, and if yes, obtains a TDF-based mode of price calculation for the terminal used on the home network of the terminal.

Specifically, the PCRF receives the IP-CAN session request message sent by the IP Edge, obtains the network identifier of the home network of the terminal from the terminal identifier carried in the IP-CAN session request message, and compares the obtained network identifier with a stored network identifier of a local network, and if the network identifiers are different, the PCRF determines that the terminal is a roaming terminal. The TDF-based mode of price calculation for the terminal used on the home network of the terminal is obtained according to the obtained network identifier and a stored correspondence between a network identifier and a mode of price calculation for the terminal.

The PCRF obtains in advance a network identifier of each operator network and a mode of price calculation for the terminal used on the network, and stores, according to the correspondence between a network identifier and a mode of price calculation for the terminal, the obtained network identifier of each operator network and the obtained mode of price calculation for the terminal used on the network.

If it is obtained by means of comparison that the network identifier of the home network of the terminal is the same as the stored network identifier of the local network, it is determined that the terminal is not a roaming terminal, and the terminal is directly charged by using a mode of price calculation for the terminal used on the local network.

Step 422: The PCRF generates QoS information and a price calculation rule that corresponds to the TDF-based mode of price calculation for the terminal, and sends a price calculation indication message to a TDF, where the price calculation indication message carries the QoS information, the price calculation rule corresponding to the TDF-based mode of price calculation for the terminal, and the terminal identifier of the terminal.

Step 423: The TDF receives the price calculation indication message sent by the PCRF, and obtains price calculation information of the terminal according to the QoS information, the price calculation rule corresponding to the TDF-based mode of price calculation for the terminal, and the terminal identifier of the terminal that are carried in the price calculation indication message.

Specifically, the TDF receives the price calculation indication message sent by the PCRF, and provides, according to the QoS information and the terminal identifier of the terminal that are carried in the price calculation indication message, a bandwidth specified in the QoS information to the terminal, to ensure normal communication of the terminal. The TDF detects and records communication data of the terminal in real time, and obtains the price calculation information of the terminal according to the communication data of the terminal and the price calculation rule that is carried in the price calculation indication message.

Step 424: The TDF sends a charging processing request message to a price calculation system of the home network, where the charging processing request message carries the price calculation information and the terminal identifier of the terminal.

The TDF obtains the network identifier of the home network of the terminal from the terminal identifier carried in the price calculation indication message, and sends the charging processing request message to the price calculation system of the home network according to the obtained network identifier, where the charging processing request message carries the price calculation information and the terminal identifier of the terminal, so that the price calculation system charges the terminal according to the price calculation information and the terminal identifier of the terminal.

Step 425: The price calculation system receives the charging processing request message sent by the TDF, and charges the terminal according to the price calculation information and the terminal identifier that are carried in the charging processing request message, and the procedure ends.

Specifically, the price calculation system receives the charging processing request message sent by the TDF, determines, according to the price calculation information carried in the charging processing request message, a total fee that the terminal needs to be charged, and then charges the terminal the determined total fee according to the terminal identifier carried in the charging processing request message.

In this embodiment of the present invention, the PCEF and the IP Edge are a same network element, and when the network element is used as the network collecting element, the network element is referred to as the PCEF.

In this embodiment of the present invention, a mode of price calculation for the terminal used on a home network of a terminal is obtained; a network collecting element corresponding to the mode of price calculation for the terminal is determined according to the obtained mode of price calculation for the terminal; and a price calculation indication message is sent to the network collecting element, so that the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 5

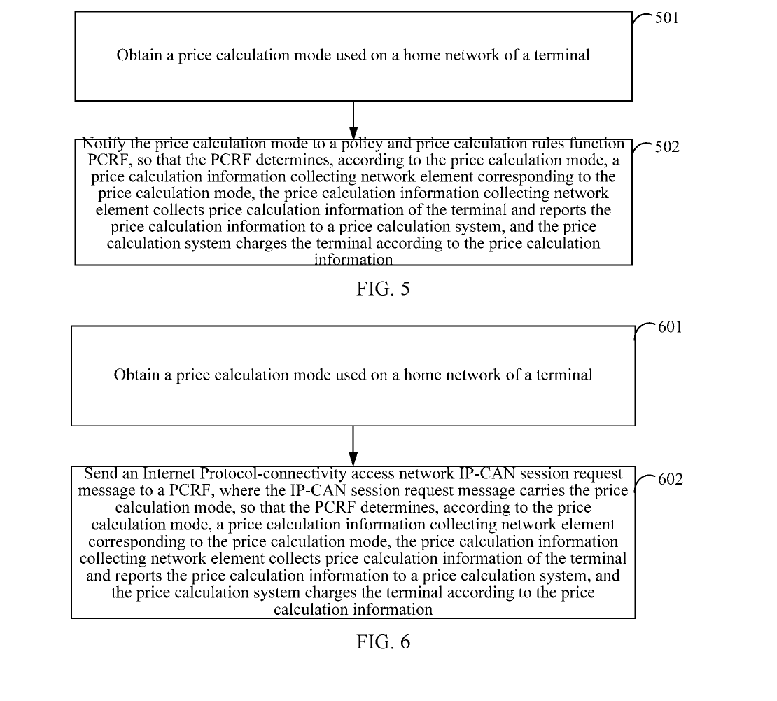

Referring to FIG. 5, this embodiment of the present invention provides a charging method, including:

Step 501: Obtain a mode of price calculation for the terminal used on a home network of a terminal.

Step 502: Notify the mode of price calculation for the terminal to a policy and charging rules function PCRF, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

Preferably, the obtaining a mode of price calculation for the terminal used on a home network of a terminal includes:
obtaining a network identifier of the home network of the terminal from a terminal identifier of the terminal, and obtaining the corresponding mode of price calculation for the terminal according to the network identifier of the home network of the terminal and a stored correspondence between a network identifier and a mode of price calculation for the terminal.

Further, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

Preferably, the notifying the mode of price calculation for the terminal to a PCRF includes:
sending the mode of price calculation for the terminal to the PCRF.

Preferably, the notifying the mode of price calculation for the terminal to a PCRF includes:
performing determining on the mode of price calculation for the terminal; and
if the mode of price calculation for the terminal is another mode of price calculation for the terminal except an AAA-based mode of price calculation for the terminal, sending a terminal identifier of the terminal to the PCRF, so that the PCRF obtains, according to the terminal identifier of the terminal, the mode of price calculation for the terminal used on the home network of the terminal.

Further, the method further includes:
if the mode of price calculation for the terminal is the AAA-based mode of price calculation for the terminal, sending a price calculation rule corresponding to the mode of price calculation for the terminal to an Internet Protocol Edge IP Edge, so that the IP Edge determines, according to the price calculation rule, that the home network of the terminal uses the AAA-based mode of price calculation for the terminal.

In this embodiment of the present invention, a mode of price calculation for the terminal used on a home network of a terminal is obtained; and the mode of price calculation for the terminal is notified to a policy and charging rules function PCRF, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 6

Referring to FIG. 6, this embodiment of the present invention provides a charging method, including:

Step 601: Obtain a mode of price calculation for the terminal used on a home network of a terminal.

Step 602: Send an Internet Protocol-connectivity access network IP-CAN session request message to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

Preferably, the obtaining a mode of price calculation for the terminal used on a home network of a terminal includes:
receiving the mode of price calculation for the terminal that is used on the home network of the terminal and that is sent by an AAA; or
receiving a price calculation rule that is sent by an AAA when the AAA determines that the home network of the terminal uses an AAA-based mode of price calculation for the terminal, and determining, according to the price calculation rule, that the home network of the terminal uses the AAA-based mode of price calculation for the terminal; or
obtaining a terminal identifier of the terminal, obtaining a network identifier of the home network of the terminal according to the terminal identifier of the terminal, and obtaining, according to the network identifier of the home network of the terminal and a stored correspondence between a network identifier and a mode of price calculation for the terminal, the mode of price calculation for the terminal used on the home network of the terminal.

Further, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

Preferably, the sending an Internet Protocol-connectivity access network IP-CAN session request message to a PCRF includes:
if the mode of price calculation for the terminal is an AAA-based mode of price calculation for the terminal, sending the IP-CAN session request message to the PCRF, where the IP-CAN session request message carries the AAA-based mode of price calculation for the terminal.

Further, the method further includes:
if the mode of price calculation for the terminal is another mode of price calculation for the terminal except the AAA-based mode of price calculation for the terminal, sending the IP-CAN session request message to the PCRF, where the IP-CAN session request message carries the terminal identifier of the terminal.

In this embodiment of the present invention, a mode of price calculation for the terminal used on a home network of a terminal is obtained, and an Internet Protocol-connectivity access network IP-CAN session request message is sent to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 7

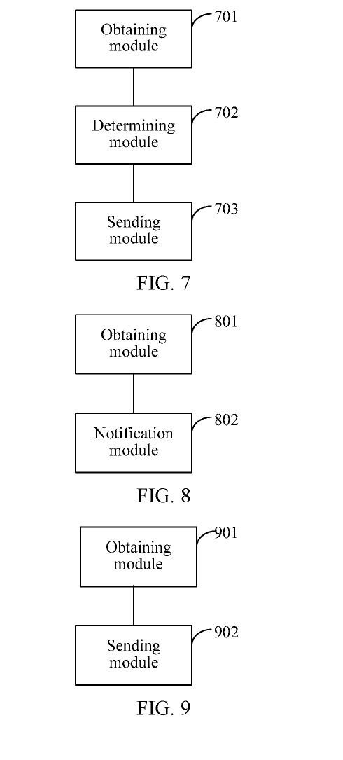

Referring to FIG. 7, this embodiment of the present invention provides a charging apparatus, including:
an obtaining module 701, configured to obtain a mode of price calculation for the terminal used on a home network of a terminal;
a determining module 702, configured to determine, according to the obtained mode of price calculation for the terminal, a network collecting element corresponding to the mode of price calculation for the terminal; and
a sending module 703, configured to send a price calculation indication message to the network collecting element, so that the network collecting element collects price calculation information of the terminal and reports the price calculation information to a price calculation system, and the price calculation system charges the terminal according to the price calculation information.

The obtaining module 701 includes:
a first receiving unit, configured to receive the mode of price calculation for the terminal that is used on the home network of the terminal and that is sent by a policy and charging enforcement function PCEF; or
a second receiving unit, configured to receive a terminal identifier sent by a PCEF, obtain a network identifier of the home network of the terminal from the terminal identifier, and obtain, according to the obtained network identifier and a stored correspondence between a network identifier and a mode of price calculation for the terminal, the mode of price calculation for the terminal used on the home network of the terminal.

Further, the apparatus further includes:
an obtaining and storage module, configured to obtain a network identifier of each network and a mode of price calculation for the terminal used on each network, and store the obtained mode of price calculation for the terminal used on each network and the obtained network identifier of each network according to a correspondence between a network identifier and a mode of price calculation for the terminal.

The determining module 702 is configured to obtain a type of a corresponding network collecting element according to the obtained mode of price calculation for the terminal and a stored correspondence between a mode of price calculation for the terminal and a type of a network collecting element, and determine the network collecting element corresponding to the obtained type as the network collecting element corresponding to the mode of price calculation for the terminal.

In this embodiment of the present invention, a mode of price calculation for the terminal used on a home network of a terminal is obtained; a network collecting element corresponding to the mode of price calculation for the terminal is determined according to the obtained mode of price calculation for the terminal; and a price calculation indication message is sent to the network collecting element, so that the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 8

Referring to FIG. 8, this embodiment of the present invention provides a charging apparatus, including:
an obtaining module 801, configured to obtain a mode of price calculation for the terminal used on a home network of a terminal; and
a notification module 802, configured to notify the mode of price calculation for the terminal to a policy and charging rule function PCRF, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

The obtaining module 801 is configured to obtain a network identifier of the home network of the terminal from a terminal identifier of the terminal, and obtain the corresponding mode of price calculation for the terminal according to the network identifier of the home network of the terminal and a stored correspondence between a network identifier and a mode of price calculation for the terminal.

Further, the apparatus further includes:
an obtaining and storage module, configured to obtain a network identifier of each network and a mode of price calculation for the terminal used on each network, and store the obtained mode of price calculation for the terminal used on each network and the obtained network identifier of each network according to a correspondence between a network identifier and a mode of price calculation for the terminal.

The notification module 802 is configured to send the mode of price calculation for the terminal to the PCRF.

The notification module 802 includes:
a determining unit, configured to perform determining on the mode of price calculation for the terminal; and
a sending module, configured to: if the mode of price calculation for the terminal is another mode of price calculation for the terminal except an AAA-based mode of price calculation for the terminal, send a terminal identifier of the terminal to the PCRF, so that the PCRF obtains, according to the terminal identifier of the terminal, the mode of price calculation for the terminal used on the home network of the terminal.

The notification module 802 is further configured to: if the mode of price calculation for the terminal is the AAA-based mode of price calculation for the terminal, send a price calculation rule corresponding to the mode of price calculation for the terminal to an Internet Protocol Edge IP Edge, so that the IP Edge determines, according to the price calculation rule, that the home network of the terminal uses the AAA-based mode of price calculation for the terminal.

In this embodiment of the present invention, a mode of price calculation for the terminal used on a home network of a terminal is obtained; and the mode of price calculation for the terminal is notified to a policy and charging rules function PCRF, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 9

Referring to FIG. 9, this embodiment of the present invention provides a charging apparatus, including:
an obtaining module 901, configured to obtain a mode of price calculation for the terminal used on a home network of a terminal; and
a sending module 902, configured to send an Internet Protocol-connectivity access network IP-CAN session request message to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

The obtaining module 901 includes:
a first receiving unit, configured to receive the mode of price calculation for the terminal that is used on the home network of the terminal and that is sent by an AAA; or
a second receiving unit, configured to receive a price calculation rule that is sent by an AAA when the AAA determines that the home network of the terminal uses an AAA-based mode of price calculation for the terminal, and determine, according to the price calculation rule, that the home network of the terminal uses the AAA-based mode of price calculation for the terminal; or
an obtaining unit, configured to obtain a terminal identifier of the terminal, obtain a network identifier of the home network of the terminal according to the terminal identifier of the terminal, and obtain, according to the network identifier of the home network of the terminal and a stored correspondence between a network identifier and a mode of price calculation for the terminal, the mode of price calculation for the terminal used on the home network of the terminal.

Further, the apparatus further includes:
an obtaining and storage module, configured to obtain a network identifier of each network and a mode of price calculation for the terminal used on each network, and store the obtained mode of price calculation for the terminal used on each network and the obtained network identifier of each network according to a correspondence between a network identifier and a mode of price calculation for the terminal.

The sending module 902 is configured to: if the mode of price calculation for the terminal is an AAA-based mode of price calculation for the terminal, send the IP-CAN session request message to the PCRF, where the IP-CAN session request message carries the AAA-based mode of price calculation for the terminal.

The sending module 902 is further configured to: if the mode of price calculation for the terminal is another mode of price calculation for the terminal except the AAA-based mode of price calculation for the terminal, send the IP-CAN session request message to the PCRF, where the IP-CAN session request message carries the terminal identifier of the terminal.

In this embodiment of the present invention, a mode of price calculation for the terminal used on a home network of a terminal is obtained, and an Internet Protocol-connectivity access network IP-CAN session request message is sent to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 10

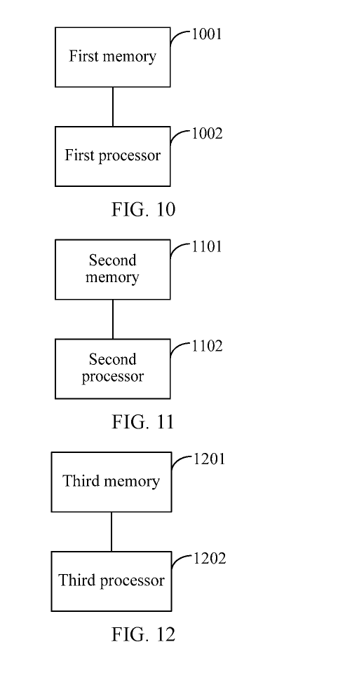

Referring to FIG. 10, this embodiment of the present invention provides a charging apparatus, where the apparatus includes a first memory 1001 and a first processor 1002, configured to execute the following charging method, including:
obtaining a mode of price calculation for the terminal used on a home network of a terminal;
determining, according to the obtained mode of price calculation for the terminal, a network collecting element corresponding to the mode of price calculation for the terminal; and
sending a price calculation indication message to the network collecting element, so that the network collecting element collects price calculation information of the terminal and reports the price calculation information to a price calculation system, and the price calculation system charges the terminal according to the price calculation information.

Preferably, the obtaining a mode of price calculation for the terminal used on a home network of a terminal includes:
receiving the mode of price calculation for the terminal that is used on the home network of the terminal and that is sent by a policy and charging enforcement function PCEF; or
receiving a terminal identifier sent by a PCEF, obtaining a network identifier of the home network of the terminal from the terminal identifier, and obtaining, according to the obtained network identifier and a stored correspondence between a network identifier and a mode of price calculation for the terminal, the mode of price calculation for the terminal used on the home network of the terminal.

Further, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

Preferably, the determining, according to the obtained mode of price calculation for the terminal, a network collecting element corresponding to the mode of price calculation for the terminal includes:
obtaining a type of a corresponding network collecting element according to the obtained mode of price calculation for the terminal and a stored correspondence between a mode of price calculation for the terminal and a type of a network collecting element, and determining the network collecting element corresponding to the obtained type as the network collecting element corresponding to the mode of price calculation for the terminal.

In this embodiment of the present invention, a mode of price calculation for the terminal used on a home network of a terminal is obtained; a network collecting element corresponding to the mode of price calculation for the terminal is determined according to the obtained mode of price calculation for the terminal; and a price calculation indication message is sent to the network collecting element, so that the network collecting element collects price calculation information of the terminal, and a price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 11

Referring to FIG. 11, this embodiment of the present invention provides a charging apparatus, where the apparatus includes a second memory 1101 and a second processor 1102, configured to execute the following charging method, including:
obtaining a mode of price calculation for the terminal used on a home network of a terminal; and
notifying the mode of price calculation for the terminal to a policy and charging rules function PCRF, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

Preferably, the obtaining a mode of price calculation for the terminal used on a home network of a terminal includes:
obtaining a network identifier of the home network of the terminal from a terminal identifier of the terminal, and obtaining the corresponding mode of price calculation for the terminal according to the network identifier of the home network of the terminal and a stored correspondence between a network identifier and a mode of price calculation for the terminal.

Further, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

Preferably, the notifying the mode of price calculation for the terminal to a PCRF includes:
sending the mode of price calculation for the terminal to the PCRF.

Preferably, the notifying the mode of price calculation for the terminal to a PCRF includes:
performing determining on the mode of price calculation for the terminal; and
if the mode of price calculation for the terminal is another mode of price calculation for the terminal except an AAA-based mode of price calculation for the terminal, sending a terminal identifier of the terminal to the PCRF, so that the PCRF obtains, according to the terminal identifier of the terminal, the mode of price calculation for the terminal used on the home network of the terminal.

Further, the method further includes:
if the mode of price calculation for the terminal is the AAA-based mode of price calculation for the terminal, sending a price calculation rule corresponding to the mode of price calculation for the terminal to an Internet Protocol Edge IP Edge, so that the IP Edge determines, according to the price calculation rule, that the home network of the terminal uses the AAA-based mode of price calculation for the terminal.

In this embodiment of the present invention, a mode of price calculation for the terminal used on a home network of a terminal is obtained; and the mode of price calculation for the terminal is notified to a policy and charging rules function PCRF, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

### Embodiment 12

Referring to FIG. 12, this embodiment of the present invention provides a charging apparatus, where the apparatus includes a third memory 1201 and a third processor 1202, configured to execute the following charging method, including:
obtaining a mode of price calculation for the terminal used on a home network of a terminal; and
sending an Internet Protocol-connectivity access network IP-CAN session request message to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information.

Preferably, the obtaining a mode of price calculation for the terminal used on a home network of a terminal includes:
receiving the mode of price calculation for the terminal that is used on the home network of the terminal and that is sent by an AAA; or
receiving a price calculation rule that is sent by an AAA when the AAA determines that the home network of the terminal uses an AAA-based mode of price calculation for the terminal, and determining, according to the price calculation rule, that the home network of the terminal uses the AAA-based mode of price calculation for the terminal; or
obtaining a terminal identifier of the terminal, obtaining a network identifier of the home network of the terminal according to the terminal identifier of the terminal, and obtaining, according to the network identifier of the home network of the terminal and a stored correspondence between a network identifier and a mode of price calculation for the terminal, the mode of price calculation for the terminal used on the home network of the terminal.

Further, before the obtaining a mode of price calculation for the terminal used on a home network of a terminal, the method further includes:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

Preferably, the sending an Internet Protocol-connectivity access network IP-CAN session request message to a PCRF includes:
if the mode of price calculation for the terminal is an AAA-based mode of price calculation for the terminal, sending the IP-CAN session request message to the PCRF, where the IP-CAN session request message carries the AAA-based mode of price calculation for the terminal.

Further, the method further includes:
if the mode of price calculation for the terminal is another mode of price calculation for the terminal except the AAA-based mode of price calculation for the terminal, sending the IP-CAN session request message to the PCRF, where the IP-CAN session request message carries the terminal identifier of the terminal.

In this embodiment of the present invention, a mode of price calculation for the terminal used on a home network of a terminal is obtained, and an Internet Protocol-connectivity access network IP-CAN session request message is sent to a PCRF, where the IP-CAN session request message carries the mode of price calculation for the terminal, so that the PCRF determines, according to the mode of price calculation for the terminal, a network collecting element corresponding to the mode of price calculation for the terminal, the network collecting element collects price calculation information of the terminal and reports the price calculation information to a price calculation system, and the price calculation system charges the terminal according to the price calculation information. A mode of price calculation for the terminal used on a home network of a roaming terminal is obtained for the roaming terminal, and a network collecting element corresponding to the mode of price calculation for the terminal sends price calculation information of the terminal to a price calculation system of the home network; therefore, the roaming terminal can be successfully charged.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, an optical disc, or the like.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A method for calculating price for a terminal, wherein the method comprises:
obtaining a mode of price calculation for a terminal used on a home network of the terminal;
determining, according to the obtained mode of the price calculation for the terminal, a network collecting element corresponding to the mode of the price calculation for the terminal, the network collecting element being configured to collect price calculation information; and
sending a price calculation indication message to the network collecting element, to enable the network collecting element to collect price calculation information of the terminal and report the price calculation information to a price calculation system for calculating price for the terminal according to the price calculation information.

2. The method according to claim 1, wherein the obtaining the mode of price calculation for the terminal used on a home network of a terminal comprises:
receiving the mode of price calculation for the terminal that is used on the home network of the terminal and that is sent by a policy and charging enforcement function (PCEF); or
receiving a terminal identifier sent by a PCEF, obtaining a network identifier of the home network of the terminal from the terminal identifier, and obtaining, according to the obtained network identifier and stored correspondences between network identifiers and modes of price calculation for terminals, the mode of price calculation for the terminal used on the home network of the terminal.

3. The method according to claim 1, before the obtaining the mode of price calculation for the terminal used on the home network of the terminal, further comprising:
obtaining a network identifier of each network and a mode of price calculation used on each network, and storing a correspondence between the obtained network identifier of each network and a mode of price calculation used on the network.

4. The method according to claim 1, wherein the determining, according to the obtained mode of price calculation for the terminal, the network collecting element corresponding to the mode of price calculation for the terminal comprises:
obtaining a type of a corresponding network collecting element according to the obtained mode of price calculation for the terminal and a stored correspondence between a mode of price calculation for the terminal and a type of a network collecting element, and determining the network collecting element corresponding to the obtained type as the network collecting element corresponding to the mode of price calculation for the terminal.

5. A method for calculating price for a terminal, wherein the method comprises:
obtaining a mode of price calculation for the terminal used on a home network of a terminal; and
sending an Internet Protocol-connectivity access network IP-CAN session request message to a PCRF, wherein the IP-CAN session request message carries the mode of price calculation for the terminal, so that the PCRF determines, according to the mode of price calculation for the terminal, a network collecting element corresponding to the mode of price calculation for the terminal, the network collecting element collecting price calculation information of the terminal and reporting the price calculation information to a price calculation system, and the price calculation system calculates the price for the terminal according to the price calculation information.

6. The method according to claim 5, wherein the obtaining a mode of price calculation for the terminal used on a home network of a terminal comprises:
receiving the mode of price calculation for the terminal that is used on the home network of the terminal and that is sent by an AAA server; or
receiving a price calculation rule that is sent by an AAA when the AAA determines that the home network of the terminal uses an AAA-based mode of price calculation for the terminal, and determining, according to the price calculation rule, that the home network of the terminal uses the AAA-based mode of price calculation for the terminal; or
obtaining a terminal identifier, obtaining a network identifier of the home network of the terminal according to the terminal identifier, and obtaining, according to the network identifier of the home network of the terminal and stored correspondences between network identifiers and modes of price calculation for terminals, the mode of price calculation for the terminal used on the home network of the terminal.

7. The method according to claim 5, before the obtaining the mode of price calculation for the terminal used on a home network of a terminal, further comprising:
obtaining a network identifier of each network and a mode of price calculation for the terminal used on each network, and storing the obtained mode of price calculation for the terminal used on each network and the obtained network identifier of each network according to a correspondence between a network identifier and a mode of price calculation for the terminal.

8. The method according to claim 5, wherein the sending an Internet Protocol-connectivity access network IP-CAN session request message to a PCRF comprises:
if the mode of price calculation for the terminal is an AAA-based mode of price calculation for the terminal, sending the IP-CAN session request message to the PCRF, wherein the IP-CAN session request message carries the AAA-based mode of price calculation for the terminal.

9. The method according to claim 8, wherein the method further comprises:
if the mode of price calculation for the terminal is another mode of price calculation for the terminal except the AAA-based mode of price calculation for the terminal, sending the IP-CAN session request message to the PCRF, wherein the IP-CAN session request message carries the terminal identifier of the terminal.

10. A charging apparatus, wherein the apparatus comprises:
a receiver, configured to obtain a mode of price calculation for the terminal used on a home network of a terminal;
a processor, configured to determine, according to the obtained mode of price calculation for the terminal, a network collecting element corresponding to the mode of price calculation for the terminal, the network collecting element being configured to collect price calculation information; and
a sender, configured to send a price calculation indication message to the network collecting element to enable the network collecting element to collect price calculation information of the terminal and report the price calculation information to a price calculation system for calculating price for the terminal according to the price calculation information.

11. The apparatus according to claim 10, wherein
the receiver, configured to receive the mode of price calculation for the terminal that is used on the home network of the terminal and that is sent by a policy and charging enforcement function PCEF; or
configured to receive a terminal identifier sent by a PCEF, obtain a network identifier of the home network of the terminal from the terminal identifier, and obtain, according to the obtained network identifier and stored correspondences between network identifiers and modes of price calculation for terminals, the mode of price calculation for the terminal used on the home network of the terminal.

12. The apparatus according to claim 10, wherein
the processor is further configured to obtain a network identifier of each network and a mode of price calculation used on each network, and store a correspondence between the obtained network identifier of each network and a mode of price calculation used on the network.

13. The apparatus according to claim 10, wherein the processor is configured to obtain a type of a corresponding network collecting element according to the obtained mode of price calculation for the terminal and a stored correspondence between a mode of price calculation for the terminal and a type of a network collecting element, and determine the network collecting element corresponding to the obtained type as the network collecting element corresponding to the mode of price calculation for the terminal.
